(19) United States
(12) Patent Application Publication
(10) Pub. No.: US 2004/0079146 A1
(43) Pub. Date: Apr. 29, 2004

(54) Method and device for measuring the thickness of a liquid layer

(76) Inventor: Wolfgang Eberhard Luxem, Kiel (DE)

Correspondence Address: Lawrence P. Kessler, NexPress Solutions LLC, Patent Department, 1447 St. Paul Street, Rochester, NY, 14653-7103, US

(21) Appl. No.: 10/359,977

(22) Filed: Feb. 7, 2003

(30) Foreign Application Priority Data
Mar. 19, 2002 (DE) 102 12 076.5

(51) Int. Cl. G01B 21/08

(52) U.S. Cl. 73/150 R

(57) ABSTRACT

Determining the thickness of the liquid layer on a rough, poorly reflecting surface with a radiation source transmitting a beam to the surface with the liquid layer, a radiation detector that receives the beam reflected from the surface and liquid layer, and the thickness of the liquid layer on the surface being determined on the basis of a measurement of the degree of gloss and/or a diffused light measurement by the beam received.

### FIELD OF THE INVENTION

This invention relates in general to measuring the thickness of a liquid layer on a rough poorly reflecting surface by measuring gloss.

### BACKGROUND OF THE INVENTION

This description refers to liquid layers on surfaces, in particular to an oil film lying on the surface of a drum that is used in a printer. In this case, a liquid, oil film or oil layer is applied to a cylinder, particularly on an application roller or an application drum of a printer, whereby the application roller is used to fuse a toner or toner material by pressure and heat on a stock, as described below. For example, with electrophotographic printers, a toner material is applied to paper sheets and subsequently fused on the paper sheet. To this end, heated application rollers are often used, which effectively make the toner material stick to the paper sheet by force fitting with high pressure and heat, gripping the paper sheet from above and below.

The problem with this conventional fusing method is that, in between the heated application roller and the stock, in particular the toner material, adhesive forces are exerted, making it difficult to separate the heated application roller from the stock. As a remedy, a liquid layer is applied to the heated application roller, which ensures a detachment of the heated application roller from the stock once the toner material has been fused. To prevent any disadvantages, care must be taken that the thickness of the liquid layer always lies within a certain range and that it does not assume any values that are too big or too small. If the values of the liquid layer thickness are too small, the above-mentioned disadvantages occur, and if values of the liquid layer thickness are too large, the disadvantages consist of oily, too glossy printing results, and, particularly with duplex printing, of the fouling of the printer by the liquid applied.

It is thus desirable to determine the liquid layer thickness on the surface and, if necessary to correct it. U.S. Pat. No. 5,001,353 describes a method and a device for measuring the thickness of layers on the moved sheet. To this end, an ultraviolet beam is directed to the layer and the fluorescence emitted by the sheet, is captured by a camera. By a mathematical relationship between the beam captured by the camera and reflected by the sheet and the thickness of the layer on the plate, the thickness of the layer can be determined. In this case, the generation of an ultraviolet beam and the preparation of a camera with corresponding additional characteristics are necessary. Both are expensive. Furthermore, a smooth surface is required with this recommended solution of the state-of-the-art, in order to obtain the appropriate measuring results.

### SUMMARY OF THE INVENTION

In view of the above, this invention is directed to determining a reliable thickness of a liquid layer particularly on a rough and poorly reflecting surface. In measuring the thickness of a liquid layer on a surface, particularly measuring the thickness of an oil layer on a printer, a radiation source emits a beam to the surface with the liquid layer, a radiation detector receives the beam reflected by the surface and the liquid layer, and the thickness of the liquid layer is determined on the basis of a measurement of the degree of gloss by the received beam. Furthermore, a method is available for measuring the thickness of a liquid layer on a surface, in particular for measuring the thickness of an oil layer on a printer, whereby a radiation source emits a beam to the surface with the liquid layer, a radiation detector that receives the beam reflected by the surface and by the liquid layer, and the thickness of the liquid layer on the surface is determined on the basis of a measurement of the diffused light by the beam received.

The beam from the radiation source is preferably polarized perpendicular to the plane of incidence of the surface and the polarization direction of the beam from the radiation source and an analyzer in front of the radiation detector is the same. In this manner, the beam received by the radiation detector is maximally filtered and during the measurement of the degree of gloss, undesired diffused light from the beam received by the radiation detector is also maximally filtered. As indicated by the measurements, a suppression of the diffused light cuts it approximately in half. The gloss desired during the measurement of the degree of gloss, which is reflected by the surface and the liquid layer, can be obtained by polarization, and the analyzer, that has the same polarization direction as the beam, can consequently pass through and be received by the radiation detector.

With a special embodiment of the invention, the rotation angle of the cylinder is measured at certain distances and the thickness of the liquid layer of the cylinder to the respective rotation angle is allocated. This makes it possible to distinguish between the various areas on the surface with respect to the thickness of the liquid layer on the surface. This characteristic is particularly useful, since the distribution of the fluid on the surface of printers is uneven. Selection of the angle of incidence of the beam from the radiation source with the Brewster angle achieves the best results with respect to the measurement of the degree of gloss.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawing, in which:

FIG. 1 shows a schematic block diagram of an embodiment of the invention.

### DETAILED DESCRIPTION OF THE INVENTION

Referring now to the accompanying drawing, a schematic block diagram of an embodiment of the invention shown is a lateral view of a drum 10, which rotates in the direction, illustrated by the direction arrows, in particular an application roller of a printer. The drum 10 in the printer is used to fuse toner applied to the stock to mesh it with the stock. To this end, the drum 10 exerts pressure on the stock with toner and it is also heated, such as by an internal heater, whereby the heat of the drum 10 melts a solid toner and contributes considerably to the fusing of the toner on the stock. On the surface of the drum 10, there is a liquid layer 12, which in the following special case is an oil layer, which is applied to the drum 10 from a dispensing device 7 via a metering roller 5 and a donor roller 6. The dose of liquid on the stock can be determined by the knowledge of the thickness of the liquid layer 12 on the drum 10 and the knowledge of the material used to make the drum 10 and of the stock.

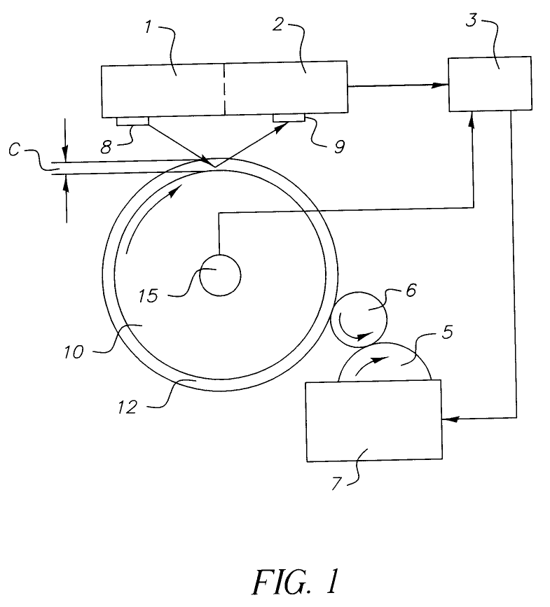

The liquid layer 12 on the drum 10 is prepared in the customary manner by the dispensing device 7 via a donor roller 6 and a metering roller 5, which are incorporated in the dispensing device. The oil to be applied on the drum 10 is located in a container of the dispensing device 7, which is collected by the surface of the metering roller 5 made of metal, moving in the direction of the arrow, and by touching the rubber-coated donor roller 6, it is rolled onto the latter. The metering roller 5, which rotates in an oil bath of the dispensing device 7, on a non-woven material, moves in the direction of the arrow opposite the donor roller 6 and transfer the liquid layer 12 to the drum 10 by contact. For clarity purposes, the liquid layer 12 in FIG. 1 is drawn considerably thicker in comparison with the drum 10. The thickness of the liquid layer 12 is indicated in the figure with the dimensions c. The metering roller 5 and the donor roller 6 are driven by drum 10, which is driven by its own drive or by friction.

Another possibility of applying the liquid layer 12 to the drum 10 consists of passing an oil-soaked cloth over drum 10. In the present embodiment, the thickness of the oil layer of drum 10, in this case, an application drum or an application roller of the printer, is determined. It is also conceivable that the metering roller 5 and/or on the donor roller 6 can be used when determining the thickness of the oil layer.

The drum 10 has a rough surface, whereby the roughness of the surface lies in the micrometer range. When oil is applied, it is distributed first into the deep areas or valleys of the surface of the drum 10, and which fills it up, until ideally a closed liquid layer 12 is formed. Once the liquid layer 12 has been applied, an increase in the gloss of the surface is visibly observed. Gloss is a sense impression that occurs during the reflection of light on a surface and which is perceived by human eyes. A smooth, high-finished surface reflects the directed light and without diffusion, whereby the angle of incidence and the angle of reflection on the surface are the same.

The gloss of the surface of the drum 10 is a measurement for liquid layer 12 borne by the drum 10. A characteristic curve of the gloss as a function of the thickness of the liquid layer 12 can thus be generated. In order to determine the thickness of the liquid layer 12, a radiation source 1 and a radiation detector 2 are arranged with the drum 10. The radiation source 1 and the radiation detector 2 are arranged in a single housing in this example. The radiation source 1 emits a light beam with a certain polarization direction and with a flat angle in the direction of the rotating drum 10 with the liquid layer 12. The radiation source 1 can contain a laser device, which emits parallel laser beams; the radiation detector 2 can contain a photo diode array for receiving the beam reflected by the surface. Various angles of incidence of the light beam can be positioned for various degrees of gloss.

The light beam from the radiation source 1 is schematically illustrated in the figure with an arrow from the radiation source 1 to the drum 10, while the light beam reflected is schematically illustrated in the figure with an arrow from the drum 10 to the radiation detector 2. The light beam is reflected by the surface of the drum 10 and the liquid layer 12. By selecting a flat angle that hits the light beam on the surface of the drum 10, the portion of the gloss from the light beam is basically reflected by the surface of the drum 10 with liquid layer 12 in the direction of the radiation detector 2; however, the undesired spurious radiation is not directed and basically does not reach the radiation detector 2. The preferred angle of incidence of the beam on the drum 10 is chosen in consideration of the surface condition of the drum 10, i.e., the surface roughness, the preferential direction, the curvature of the drum 10 and the reflectivity. Generally speaking, the gloss clearly increases if the drum 10 has a low reflectivity.

In front of the radiation detector 2, an analyzer 9 is arranged that filters the light beam reflected by the drum 10. The analyzer 9 has a polarization direction that is identical to the polarization direction of the light beam from the radiation source 1. This means that only light from the polarization direction used is allowed to pass. The radiation source 1 and the radiation detector 2 have the same angle of incidence, which ideally is the Brewster angle of the liquid. In this case, the angle of incidence is defined by the angle between the light beam and the standard surface. The Brewster angle αis calculated using the formula tan α=n, where n is the refraction index of the liquid. Water, for example has a Brewster angle of 53°.

The intensity of the gloss passing through analyzer 9 is determined in the radiation detector 2. The gloss received from the radiation detector 2 is composed of the gloss of the surface of the liquid layer 12 and the gloss of the surface of the drum 10. By the surface of the drum 10, for example, the curvature, texture and grooves of the drum 10 and deflected portions of the beam affect the gloss received as well as diffused light, which in part comes from the coating of the drum 10. The following differences exist between the gloss and diffused light of the beam. Gloss maintains its direction; a parallel beam hitting a surface generates a parallel beam leaving the surface; gloss remains polarized, since gloss is based on the specular reflection, and gloss has a certain preferred direction. Measures to increase the gloss in the beam received are used, such as the use of a parallel beam from the radiation source 1, whereby the gloss remains parallel, a sharp point arises in the focal plane. A position-locating sensor in the radiation detector 2 locally receives a maximum; the illumination intensity at the radiation detector 2 is very high locally. If the radiation detector 2 is in the focal plane, then the image of a light spot is fuzzy and consequently attains a low illumination with the radiation detector 2. If polarized light from the radiation source 1 is used with a polarizer 8 and a polarizing analyzer 9 parallel to the polarizer at the radiation detector 2, the gloss passes unimpeded through the analyzer 9, while approximately half of the diffused light is suppressed. If the beam strikes a very weak angle, the gloss portion is increased, but the diffused light portion remains the same.

Due to the specular reflection with gloss, the parallel course of the visible radiation is maintained. This leads to a sharp point in the focal plane of the radiation detector 2. If a position-locating radiation detector 2 is used, a narrowly defined maximum of the intensity is obtained. Contrary to gloss, diffused light is unpolarized as a first approximation. Since the diffusion of the visible radiation usually contains no polarization, the diffused light has no polarization. However, with many surfaces that the beam strikes, a major direction of the diffused light can be recognized.

The radiation detector 2 is connected to a computer and a control device 3 and transfers the data concerning the intensity to them. In the computer and control device 3, the intensity of the beam received is determined, and the position allocation of the intensity is evaluated. Due to the determination of the local distribution of the intensity, the diffused light can be distinguished from the gloss, which is used to determine the thickness of the oil layer or liquid layer 12.

In addition to the evaluation of the intensity of the beam received, an evaluation of the local spectral beam distribution of the gloss can be carried out in the radiation detector 2. In the case in which the light beam falls on surface of the drum 10 that has not been wetted by liquid or oil, the diffused light is basically received by the radiation detector 2, and the surface of the drum 10 in the focal plane of the radiation detector 2 has a fuzzy image. In the first approximation, the diffused light is diffused in all directions. As a function of the surface condition of the drum 10, there arises a certain preferred divergent direction. Specifically, when a first measurement is taken, the surface without liquid is irradiated by the radiation source 1; the reflected beam is received by the radiation detector 2, and data concerning the intensity of the gloss of the surface without liquid is transmitted to the computer and control device 3. Depending on the surface to be measured, various intensity characteristics are produced.

Subsequently, the liquid is applied to the surface to be measured; during a second measurement of the surface with liquid irradiated by the radiation source 1, the beam reflected by the radiation detector 2 is received and data concerning the intensity of the gloss of the surface with fluid is transmitted to the computer and control device 3. The data concerning the intensity of the gloss of the surface with and without liquid are compared with one another in the computer and control device 3. The thickness of the liquid layer 12 is determined from the data concerning the intensity of the gloss in the computer and control device 3. To this end, for each gloss value obtained by the radiation detector 2, a thickness of the liquid layer 12 is allocated in an allocation table in the computer and control device 3. The allocation table is compiled on the basis of the characteristic curve of the gloss as a function of the thickness of the liquid layer 12. The thickness of the liquid layer 12 can be reliably determined in the above-described manner.

The dispensing device 7 which is connected with the computer and control device 3, can be controlled by the thickness of the liquid layer 12. If it is determined in the computer and control device 3 that the liquid layer 12 on the drum 10 is not thick enough for the chosen application, the dispensing device 7 can be controlled so that the dispensing of fluid is suitably increased.

Furthermore, the computer and control device 3 is connected to a rotary encoder 15, which determines the rotation angle of the drum 10 at specified distances, and transmits them to the computer and control device 3. In connection with the intensity of the beam received, measured with the same distances, the thickness of the liquid layer 12 can be allocated to a specified rotation angle of the drum 10 and consequently to the area corresponding to the rotation angle on the surface of the drum 10, where the actual measurement of the degree of gloss takes place. In this manner, the allocation of the thickness of the liquid layer 12 to the drum 10 can be measured by any rotation angle and the dispensing of the liquid, oil in this case, can be controlled by the dispensing device 7, can be controlled by the computer and control device 3 depending on the rotation angle. A specific area on the surface of the drum 10, which has a low liquid layer thickness, can thus be controlled by the computer and control device 3, which controls the dispensing of fluid on the metering roller 5, with the appropriate amount of fluid applied. In a similar way, the amount of fluid that is dispensed by the dispensing device 7 to the metering roller 5, can be reduced to the appropriate measurement, if the thickness of the liquid layer 12 on a given area on the surface of the drum 10 is too great.

Furthermore, several radiation sources 1 and radiation detector 2 can be arranged in axial direction to the drum 10, which measure the thickness of the liquid layer 12 independently from one another, in order to determine the allocation of the thickness of the liquid layer 12 along the rotating axis of the drum 10 and to control according to the preceding description or the beam of the radiation source 1 can move around axially along the drum 10 and the beam reflected by the surface can be deflected to the radiation detector 2 by means of a mirror system. The last possibility has the advantage of only requiring a radiation source 1 and a radiation detector 2, and nonetheless, the entire axial length of the drum 10 can be measured.

When measuring the thickness of the liquid layer 12 on a surface, the diameter of the beam hitting the surface is normally not important. Since especially in the case of surfaces of printing drums or pressure plates, however, depressions or valleys with diameters in the range of one to five micrometers exist, for the exact measurement of the liquid layer 12 at all locations, including depressions and valleys, with a special embodiment, a light beam from the radiation source 1 is required, which has a corresponding small diameter in the range of several micrometers, in particular, one or two micrometers, in order to also detect the liquid layer thicknesses in the small depressions or valleys in the surface.

With another embodiment, instead of the above-described measurement of the degree of gloss, a measurement of diffused light is carried out, which with optical systems, in themselves, is not desired. In this case, the radiation detector 2 receives reflected diffused light from the surface by which the roughness of the surface is measured. Since the diffused light is basically reflected by the surface, the structure of the surface without liquid can be determined with the diffused light. Another possibility for measuring the structure of the surface without liquid is to use an optical profilometer. In particular, the structure of the surface of the printing drum is rough; when coating with a liquid layer 12, areas emerge that are covered with liquid and areas in which the surface of the printing drum that protrude from the liquid layer 12. The more the areas expand, in which the surface of the printing drum protrudes from the liquid layer 12, i.e., the dryer the surface is, the more the diffused light from the surface increases.

The above, described first measurement of the surface without liquid is thus carried out with a diffused light measurement, while the second measurement of the surface with liquid is carried out with a measurement of the degree of gloss. With the diffused light measurement, the angle of incidence of the beam from the radiation source 1 to the surface and the angle at which the beam is received from the surface to the radiation detector 2, with each measured between the light beam and the standard surface is changed in comparison with the measurement of the degree of gloss. The angle of incidence may, for example, amount to 45° or 90°, the receiving angle 90° or 45°. In principle, the following arrangements for the detection of the diffused light portion are reasonable. First, the radiation source 1 and the radiation detector 2 have no polarizer 8 or analyzer 9. Second, the radiation source 1 has a polarizer 8 and the radiation detector 2 has an analyzer 9, whereby the specular reflection is not suppressed, which means that the gloss with the diffused light measurement from the radiation detector 2 is basically not received. In the computer and control device 3, there is a characteristic curve of the diffused light as a function of the surface roughness for the purpose of diffused light measurement. The evaluation of both measurements takes place as described above. The preceding description is only exemplary; the invention does not apply only to the described measurements of an oil layer of an application roller of a printer, but to the measurement of the thickness of a liquid layer 12 on any surface.

The invention has been described in detail with particular reference to certain preferred embodiments thereof, but it will be understood that variations and modifications can be effected within the spirit and scope of the invention.

What is claimed is:

1. Method for measuring the thickness of a liquid layer (12) on a surface, particularly for measuring the thickness of an oil layer on a printer, comprising: a radiation source (1) transmits a beam to the surface with the liquid layer (12), a radiation detector (2) receives beams reflected from the surface and the liquid layer (12), and the thickness of the liquid layer (12) on the surface is determined by the beam received on the basis of a measurement of the degree of gloss.

2. Method according to claim 1, wherein the beam of the radiation source (1) is polarized perpendicular to the angle of incidence of the surface, and the polarization direction of the beam of the radiation source (1) and an analyzer (9) in front of the radiation detector (2) are the same.

3. Method according to claim 1, wherein the rotation angle is measured at specified distances and that the thickness of the liquid layer (12) is allocated to each rotation angle measured.

4. Method according to claim 1, wherein the angle of incidence of the beam from the radiation source (1) corresponds to the Brewster angle of the liquid.

5. Method for measuring the thickness of the liquid layer (12) on a surface, particularly for measuring the thickness of an oil layer on a printer, comprising: a radiation source (1) transmits a beam to the surface with the liquid layer (12), a radiation detector (2) receives the beam reflected by the liquid layer (12), and the thickness of the liquid layer (12) on the surface is determined on the basis of a diffused light measurement by the beam received.

6. Method according to claim 5, wherein the measuring of the thickness of the liquid layer (12) on the surface is carried out with a diffused light measurement and a measurement of the degree of gloss.

7. Device for measuring the thickness of a liquid layer (12) on a surface, particularly for measuring the thickness of an oil layer on a printer, comprising: a radiation source for transmitting a beam to a surface with the liquid layer (12), a radiation detector (2) for receiving the beam reflected by the surface and the liquid layer (12), and a device for determining the degree of gloss and/or diffused light from the beam received.

8. Device for measuring the thickness of the liquid layer (12) according to claim 7, wherein the radiation source (1) and the radiation detector (2) are carried out in one device.

9. Device for measuring the thickness of the liquid layer (12) according to claim 7, wherein said printer has an application roller which is attached to a rotary encoder (15) for measuring the rotation angle of the application roller.

10. Device for measuring the thickness of the liquid layer (12) according to claim 7, further including a screen on the radiation detector (2) to filter the diffused light.

11. Device for measuring the thickness of the liquid layer (12) according to the claim 10, further including an analyzer (9) in front of the radiation detector (2), which has the same polarization direction as that of the beam transmitted by the radiation source (1).

12. Device for measuring the thickness of the liquid layer (12) according to claim 7, wherein the beam from the radiation source (1) has a beam with a diameter in the range of a few micrometers, particularly in the range of less than two micrometers.
